(19) United States
(12) Patent Application Publication
(10) Pub. No.: US 2007/0008899 A1
(43) Pub. Date: Jan. 11, 2007

(54) System and method for monitoring VoIP call quality

(76) Inventors: Choon B. Shim, Ijamsville, MD (US); Liehua Xie, Gaithersburg, MD (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/175,030

(22) Filed: Jul. 6, 2005

(51) Int. Cl. H04J 1/16

(52) U.S. Cl. 370/252

(57) ABSTRACT

The invention relates to a system and method for monitoring VoIP call quality. In one respect, embodiments of the invention take into account the effect of bursty packet loss on perceived call quality. In another respect, embodiments of the invention take into account the effect of the recency of packet loss on perceived call quality. By modeling one or both of the foregoing effects, the accuracy of VoIP call quality measures are improved.

### FIELD OF INVENTION

The invention relates generally to the field of communications. More specifically, but not by way of limitation, the invention relates to a system and method for monitoring VoIP call quality using a modified estimation model or E-Model.

### BACKGROUND

Voice over Internet Protocol (VoIP) uses packet data over the Internet or other network as the transmission medium for voice communications (such communication sessions are referred to herein as “calls”). Packet data is susceptible to latency/delay, jitter, and loss. Any one or more of these factors can negatively effect perceived call quality. For instance, packet loss may be perceived as a popping or clicking noise by a person on the receiving end of a call. VoIP call quality monitoring is useful in identifying network maintenance that is required, adjusting network or endpoint parameters adaptively, and/or in informing packet routing decisions.

The International Telecommunication Union, Telecommunication Standardization Sector (ITU-T) introduced the E-Model as a way to estimate the expected voice quality of a telecommunications network. The E-Model is based on the idea that impairments from different sources in a network have a cumulative effect on the perceived call quality.

The E-Model formula is R=Ro−Is−Id−Ie+A, where:

R=single quality rating (a.k.a. R-factor, scaled from 1 to 100);

Ro=noise ratio factor (e.g., room noise at either side, circuit noise);

Is=impairment of voice transmission system that occurs simultaneously with speech (e.g., excessive loudness);

Id=impairment factor due to delay (e.g., echo);

Ie=equipment impairment factor (e.g., signal distortion); and

A=advantage factor (e.g., mobility).

Once calculated, the R-factor may be translated to a Mean Opinion Score (MOS) on a scale of 1 to 5. A high call quality rating would have an R-factor in the range of 80 to 90, or a MOS in the range of 4.03 to 4.34.

The conventional E-model described above has many limitations, however. One limitation is that the conventional E-Model assumes data packets are lost randomly: this is often not the case in an actual network. For example, switches and routers in a network typically buffer data packets; when the capacity of the buffering devices is exceeded (creating an overflow condition) many consecutive packets may be lost. Because non-random packet loss degrades perceived call quality to a greater extent than random packet loss, the accuracy of the conventional E-Model is lacking. What is needed is an improved system and method for monitoring VoIP call quality that accounts for instances of non-random packet loss.

### SUMMARY OF THE INVENTION

The invention relates to a system and method for monitoring VoIP call quality. In one respect, embodiments of the invention take into account the effect of bursty packet loss on perceived call quality. As used herein, packet loss may be or include network packet loss and/or buffer packet loss. Other embodiments of the invention take into account the effect of the recency of packet loss on perceived call quality. By modeling one or both of the foregoing effects, the accuracy of VoIP call quality measures are improved.

Embodiments of the invention provide a method for measuring the quality of a packet data stream including: measuring the burstiness of the packet data stream; calculating an equivalent random packet loss based on the measured burstiness; and calculating a call quality metric based on the equivalent random packet loss.

Embodiments of the invention provide a method for measuring the quality of a packet data stream including: selecting a first packet in the packet data stream; determining the loss status of a predetermined number of previous packets in the packet data stream, the previous packets being relative to the first packet; and calculating an equivalent random packet loss for the first packet based on the loss status of each of the predetermined number of previous packets.

Embodiments of the invention provide a method for measuring the quality of a packet data stream including: measuring an actual packet loss in the packet data stream; calculating an actual packet loss rate based on the measured actual packet loss; determining whether the actual packet loss rate is greater than a predetermined threshold; if the actual packet loss rate is greater than the predetermined threshold, applying a high packet loss rate algorithm; and if the actual packet loss rate is not greater than the predetermined threshold, applying a low packet loss rate algorithm.

Embodiments of the invention provide a method for measuring the quality of a call including: parsing the call into a plurality of data streams; identifying at least one most recent data stream in the plurality of data streams; and calculating an actual packet loss rate for the at least one most recent data stream.

The features and advantages of the invention will become apparent from the following drawings and detailed description.

### BRIEF DESCRIPTION OF THE DRAWINGS

Embodiments of the invention are described with reference to the following drawings, wherein:

FIG. 1 is an illustration of packet loss in a data stream;

FIG. 2 is a process flow diagram of a method for calculating a call quality metric, according to an embodiment of the invention;

FIG. 3 is a process flow diagram of a method for calculating a call quality metric, according to an embodiment of the invention;

FIG. 4 is an illustration of packet loss in a data stream;

FIG. 5 is a process flow diagram of a method for calculating a call quality metric, according to an embodiment of the invention;

FIG. 6A is an illustration of low packet loss rate in a data stream;

FIG. 6B is an illustration of high packet loss rate in a data stream;

FIG. 7 is a process flow diagram of a method for calculating a call quality metric, according to an embodiment of the invention;

FIG. 8A is a graph of call quality vs. packet loss for various burstiness levels based on experimental results using the Perceptual Evaluation of Speech Quality (PESQ) algorithm;

FIG. 8B is a graph of call quality vs. packet loss as calculated by conventional E-Model algorithm and an enhanced E-Model algorithm under random packet loss conditions;

FIG. 8C is a graph of call quality vs. packet loss as calculated by a conventional E-Model algorithm and an enhanced E-Model algorithm under moderately bursty packet loss conditions; and

FIG. 9 is a block diagram of a functional architecture, according to an embodiment of the invention.

### DETAILED DESCRIPTION

This section provides a description of improved methods for calculating call quality, empirical analysis, and an exemplary functional architecture for a system that is configured to perform the disclosed methods. Sub-headings are used below for organizational convenience. The disclosure of any particular feature is not necessarily limited to any particular section, however.

Improved Methods for Calculating Call Quality

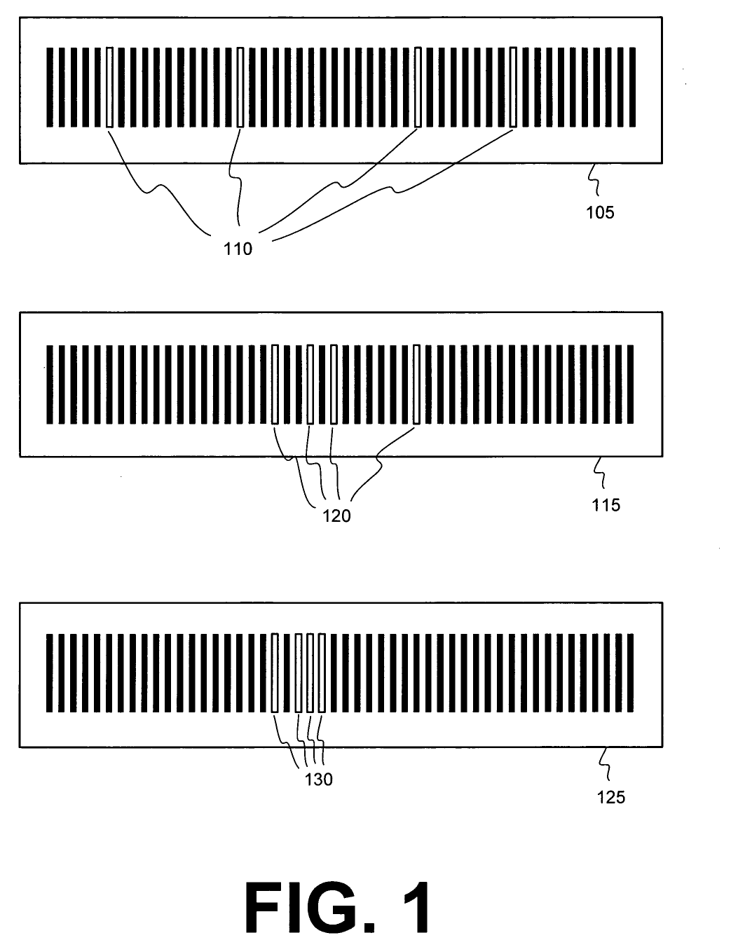

FIG. 1 is an illustration of packet loss in a data stream. FIG. 1 illustrates three packet data streams 105, 115, and 125. Data stream 105 is exemplary of random packet loss based on the relatively dispersed positioning of lost packets 110. Data stream 115 is exemplary of moderately-bursty packet loss based on the relatively closer positioning of lost packets 120. Data stream 125 is exemplary of heavily-bursty packet loss based on the very close positioning of lost packets 130. The processes described below provide a method for calculating a call quality metric for moderately-bursty or heavily-bursty packet loss.

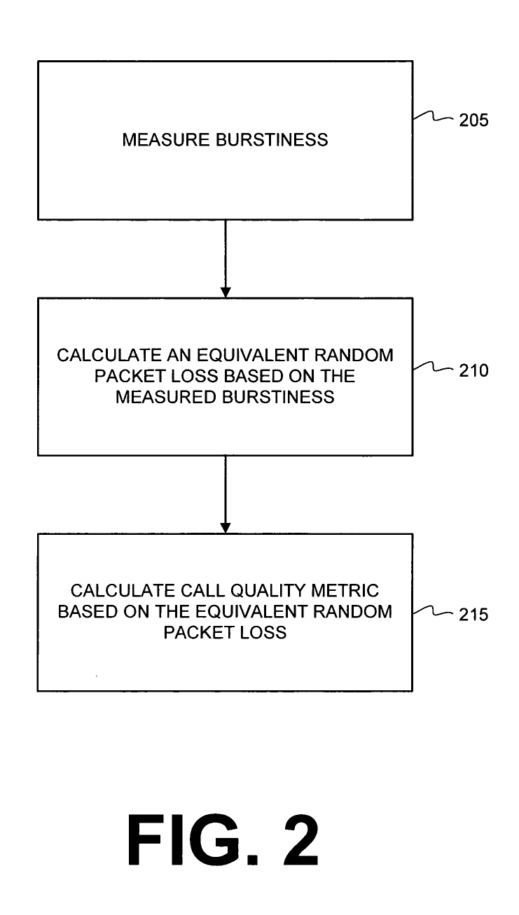

FIG. 2 is a process flow diagram of a method for calculating a call quality metric, according to an embodiment of the invention. As illustrated in FIG. 2, the process begins in step 205 by measuring packet loss burstiness (“packet loss burstiness” is also referred to herein as “burstiness”). Measuring step 205 includes identifying the position of each lost packet within a predetermined data stream. For example, with reference to FIG. 1, the output of step 205 is data indicating that lost packets 120 are in the 20^{th}, 23^{rd}, 25^{th}, and 32^{nd} positions of the 50-packet data stream 115.

Next, in step 210, the process calculates an equivalent random packet loss based on the measured burstiness. For data streams having light or moderate packet loss, the equivalent random packet loss is a number greater than the actual packet loss. For example, with respect to data stream 115, the actual packet loss is 4 (out of the 50 packets represented) and the equivalent random packet loss is a number greater than 4. For data streams having heavy packet loss, the equivalent random packet loss is a number smaller than the actual packet loss. Exemplary algorithms for calculating the equivalent random packet loss are provided below.

Finally, in step 215, the process calculates a call quality metric based on the equivalent random packet loss. The call quality metric calculated in step 215 may be based, for instance, on the conventional E-model using the equivalent random packet loss calculated in step 210. In one embodiment, the equivalent random packet loss is used to replace a packet loss probability (Ppl) parameter, which is used in calculating the equipment impairment factor (Ie).

The packet-loss dependent Effective Equipment Impairment Factor Ie-eff is derived using the codec specific value for the Equipment Impairment Factor at zero packet-loss Ie and the Packet-loss Robustness Factor Bpl, both listed in appendix I/G. 113 for several codecs. With the Packet-loss Probability Ppl, Ie-eff is calculated using the formula:

$$Ie - eff = Ie + ( 95 - Ie ) \cdot \frac{Ppl}{Ppl + Bpl}$$

This formula is given by ITU standard: ITU G107: The E-model, a computational model for use in transmission planning.

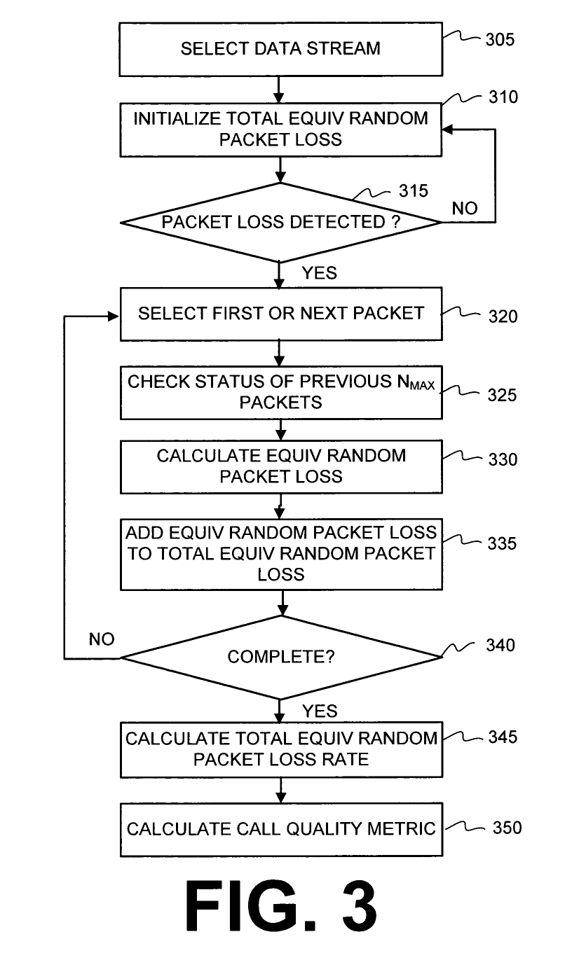

FIG. 3 is a process flow diagram of a method for calculating a call quality metric, according to an embodiment of the invention. FIG. 3 can be considered a more detailed description of the process described with reference to FIG. 2 above, although the description of FIG. 3 is only one possible embodiment, and is not intended to limit the scope of the invention since other processes may be used to achieve the operation of the invention.

After selecting a data stream segment in step 305, the process advances to step 310 to initialize the Total Equivalent Random Packet Loss (TERPL) to zero for the selected data stream segment. Next, in conditional step 315, the process determines whether at least one packet loss is detected in the selected data stream segment. Where the result of conditional step 315 is in the negative, the process returns to initialization step 310.

Where the result of conditional step 315 is in the affirmative, the process advances to step 320 to select a first or next lost packet in the data stream. Next, in step 325, the process checks the status of the previous Nₘₐₓ packets with respect to the selected first or next packet. Nₘₐₓ is a predetermined integer value. For example, where Nₘₐₓ is 8, then step 325 identifies any additional lost packets that are separated from the selected first or next lost packet by a distance of 0, 1, 2, 3, 4, 5, 6, or 7 positions in the selected data stream. A separation of 0 means that there are at least two consecutive lost packets in the selected data stream.

Then, in step 330, the process calculates an Equivalent Random Packet Loss (ERPL) for the selected lost packet based on the status of each of the previous Nₘₐₓ packets. Next, in step 335, the process adds the calculated Equivalent Random Packet Loss (ERPL) to the Total Equivalent Random Packet Loss (TERPL )for the data stream.

In conditional step 340, the process determines whether an ERPL has been calculated for each lost packet in the selected data stream. Where the result of conditional step 340 is in the negative, the process returns to step 320 to select a next lost packet in the data stream segment for which ERPL calculation is required.

Where the result of conditional step 340 is in the affirmative, the TERPL for the data stream is the sum of the equivalent random packet loss calculations for each lost packet in the selected data stream. In this instance, the process advances to step 345 to calculate a Total Equivalent Random Packet Loss Rate (TERPLR). The TERPLR is calculated by dividing the TERPL for the selected data stream by the number of packets (lost and unlost) in the selected data stream. In step 350, the process calculates a quality metric based on the TERPLR.

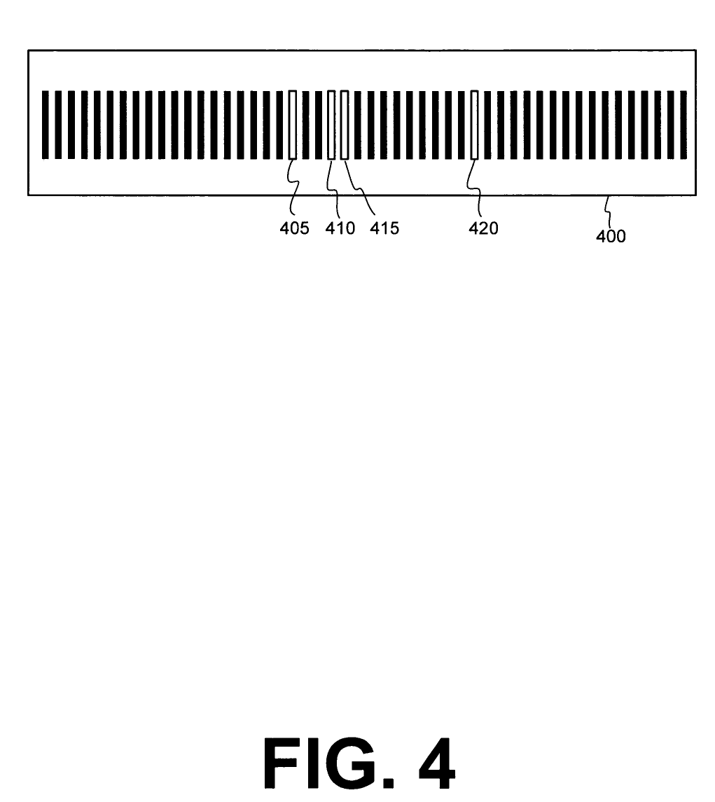

FIG. 4 is an illustration of packet loss in a data stream. As illustrated in FIG. 4, a data stream of 400 includes lost packets illustrated by packets 405, 410, 415, and 420. The following paragraphs describe applying the process of FIG. 3 to the data stream 400.

In step 305, the process selects data stream 400. In step 310, the process sets TERPL=0. In step 315, the process determines that there is at least one lost packet in data stream 400. In step 320, the process selects lost packet 405. In step 325, for an Nₘₐₓ of 8, the process determines that there are no previous lost packets within 8 positions of lost packet 405. Thus, in step 330, the ERPL for lost packet 405 is calculated to be 1. In step 335, the process calculates the TERPL to be 1.

In step 340, the process determines that there are additional lost packets in data stream 400, and the process returns to step 320 to select lost packet 410. In step 325 the process identifies lost packet 405 that is separated from selected lost packet 410 by 2 positions (within the Nₘₐₓ of 8). Accordingly, the ERPL for lost packet 410 should be greater than 1.

In one embodiment, the ERPL increase value for each lost packet within 8 positions of the selected lost packet is provided by Table 1 (where “distance” is the number of positions that a previous lost packet is separated from the selected lost packet, and “ERPL increase” is the amount that an ERPL is increased over 1 due to the measured burstiness).

TABLE 1

| | Distance | | | | | | | |
|---|---|---|---|---|---|---|---|---|
| | 0 | 1 | 2 | 3 | 4 | 5 | 6 | 7 |
| ERPL | 1 | ½ | ¼ | ⅛ | 1/16 | 1/32 | 1/64 | 1/128 |
| increase | | | | | | | | |

Using values from Table 1 in step 330, the process calculates the ERPL for lost packet 410 to be 1+¼, or 1.25. Likewise, when step 320 is repeated, the process calculates the ERPL for lost packet 415 to be 1+1+⅛, or 2.125. The ERPL for lost packet 420 is 1 (since there no previous lost packets within 8 positions of lost packet 420).

When the process determines in step 340 that ERPL has been calculated for all lost packets in data stream 400, the TERPL=(ERPL for lost packet 405)+(the ERPL for lost packet 410)+(ERPL for lost packet 415)+(ERPL for lost packet 420)=5.375. For the illustrated process flow, 5.375 is the result of the last calculation in step 335 for the selected data stream.

There are 50 packets (lost and unlost) in data stream 400. Accordingly, in step 345, the process calculates TERPLR as follows: TERPLR=5.375/50=0.1075, or 10.75%. Note that the actual packet loss rate is 8% (4 lost packets out of 50).

Alternative algorithms can be used IN STEP 330 to calculate ERPL for bursty packet loss. Tables 2 and 3 provide exemplary sets of ERPL increases for cases where Nₘₐₓ is 8.

TABLE 2

| | Distance | | | | | | | |
|---|---|---|---|---|---|---|---|---|
| | 0 | 1 | 2 | 3 | 4 | 5 | 6 | 7 |
| ERPL | 1 | ½ | ⅓ | ¼ | ⅕ | ⅙ | 1/7 | ⅛ |
| increase | | | | | | | | |

TABLE 3

| | Distance | | | | | | | |
|---|---|---|---|---|---|---|---|---|
| | 0 | 1 | 2 | 3 | 4 | 5 | 6 | 7 |
| ERPL | 8 | 7 | 6 | 5 | 4 | 3 | 2 | 1 |
| increase | | | | | | | | |

The selection of an algorithm may be based, at least in part, on a level of packet loss burstiness. In the alternative, or in combination, algorithms may be selected based on the Actual Packet Loss Rate (APLR).

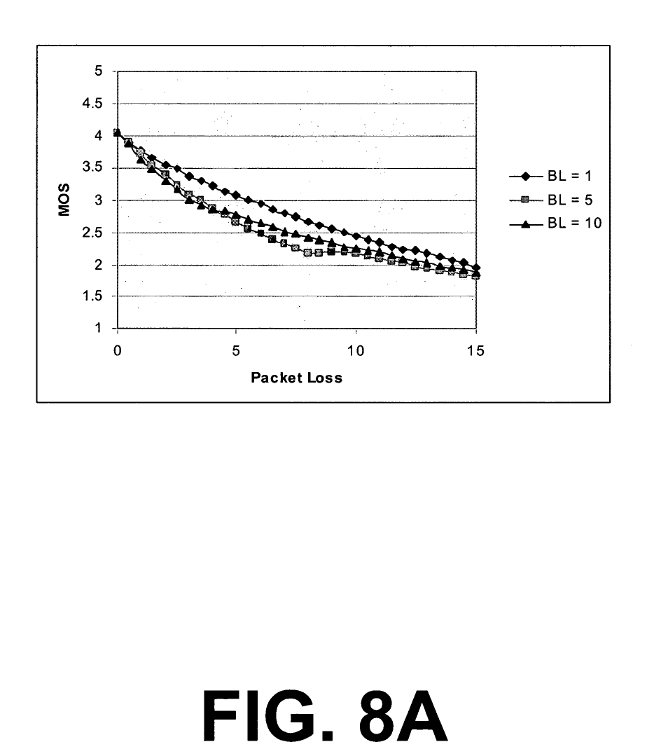

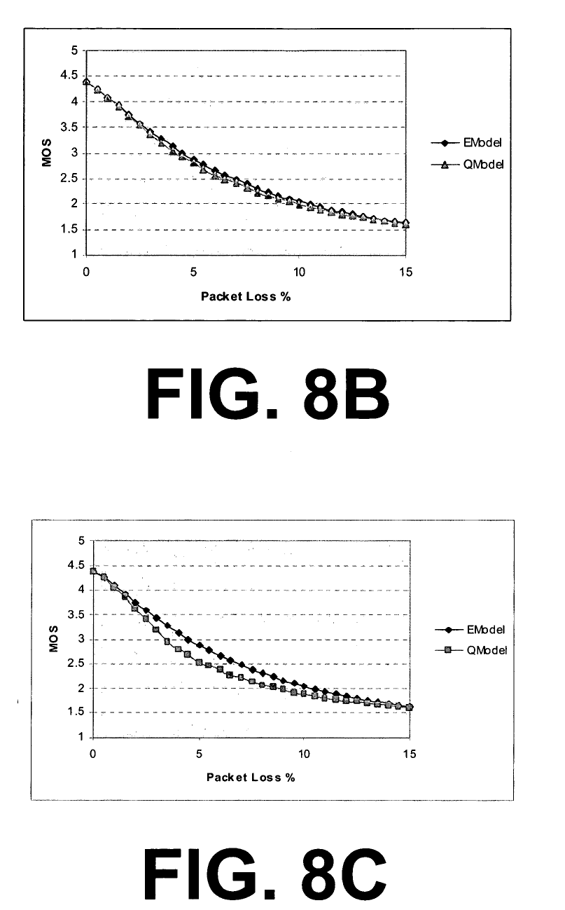

APLR is depicted as “Packet Loss” in FIG. 8A and “Packet Loss %” in FIGS. 8B and 8C. With reference to FIG. 8A, it is apparent that packet loss burstiness (BL) has less effect on MOS where the APLR is greater than approximately 5%. Accordingly, where the APLR is greater than about 5%, the ERPL may be decreased using the ERPL decrease values in Table 4.

TABLE 4

| | Distance | | | | | | | |
|---|---|---|---|---|---|---|---|---|
| | 0 | 1 | 2 | 3 | 4 | 5 | 6 | 7 |
| ERPL | ½ | ¼ | ⅛ | 1/16 | 1/32 | 1/64 | 1/128 | 1/256 |
| decrease | | | | | | | | |

This decrease may continue until the ERPLR is greater than 20%, or until the ERPLR is greater than the APLR. In the former case, the ERPLR may be set=20%, which is the upper bound of packet loss probability in the E-Model. In the latter case, the EPRLR may be set=APLR.

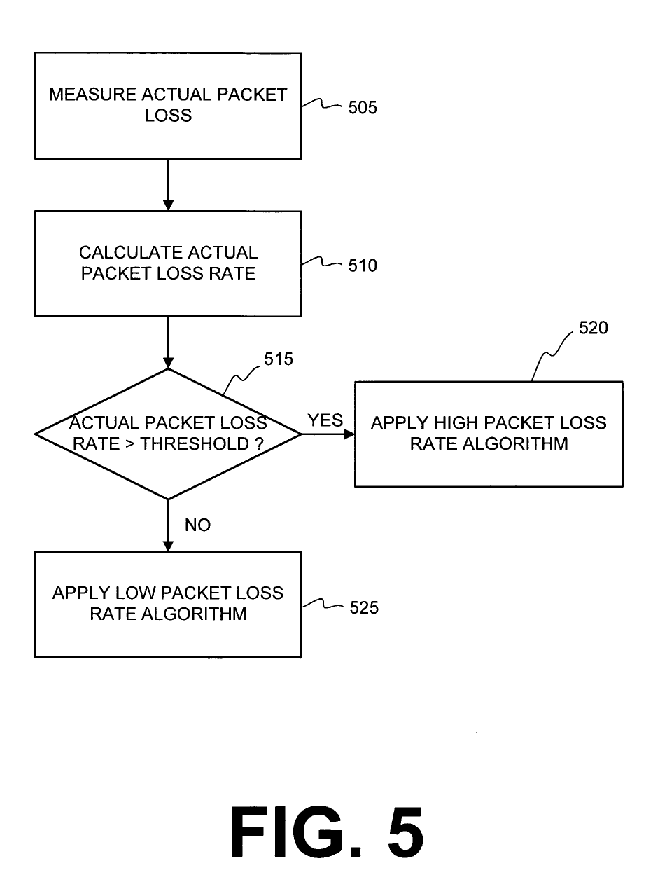

The process described below with reference to FIG. 5 illustrates more explicitly how different algorithms can be selected, in situ, in the execution of ERPL calculation steps 210 or 330.

FIG. 5 is a process flow diagram of a method for calculating a call quality metric, according to an embodiment of the invention. The process begins by selecting a data stream segment, 501. The process continues by measuring an Actual Packet Loss (APL) for the selected segment in step 505. APL is the number of actual lost packets in a selected data stream. Next, in step 510, the process calculates an Actual Packet Loss Rate (APLR) by dividing the APL by the total number of packets (lost and unlost) in the selected data stream. Preferably, the APLR is expressed as a percentage.

Next, in conditional step 515, the process determines whether the APLR is greater than a pre-determined threshold. Where the result of conditional step 515 is in the affirmative, the process advances to step 520 to apply a high packet loss rate algorithm. Where the result of conditional step 515 is in the negative, the process advances to step 525 to apply a low packet loss rate algorithm.

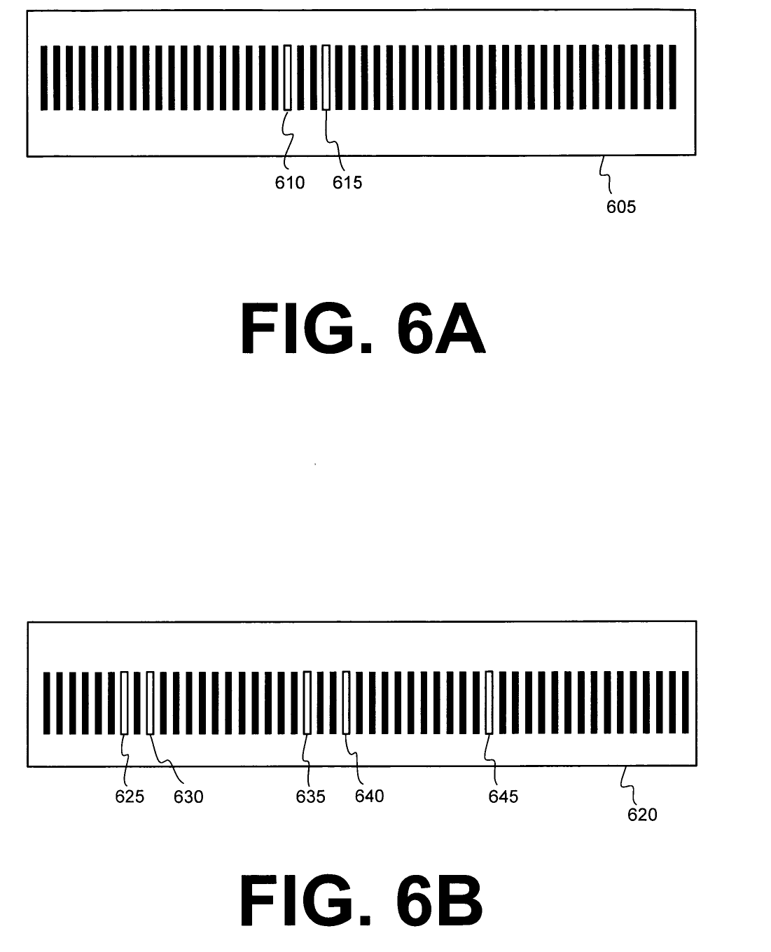

FIG. 6A is an illustration of low packet loss rate in a data stream. As shown in FIG. 6A, a data stream 605 includes lost packets 610 and 615. The APLR for data stream 605 is 4%. FIG. 6B is an illustration of high packet loss rate in a data stream. As illustrated in 6B a data stream 620 includes lost packets 625, 630, 635, 640 and 645. The APLR for data stream 620 is 10%. If the predetermined threshold in step 515 is 5%, then the process illustrated in FIG. 5 would apply different algorithms in calculating ERPL for data streams 605 and 620. For example, step 520 could apply ERPL increase values from Table 1 with regard to data stream 620, and step 525 could apply ERPL decrease values from Table 4 with regard to data stream 605.

Recency Effect

Data indicate that humans perceive and/or remember higher call quality where the quality is degraded only at a relatively early portion of a session, and lower call quality where the quality is degraded only at a relatively late portion of a session. Accordingly, it may be advantageous to adjust a given call quality value downward where the quality of the session has degraded during a late portion of the session.

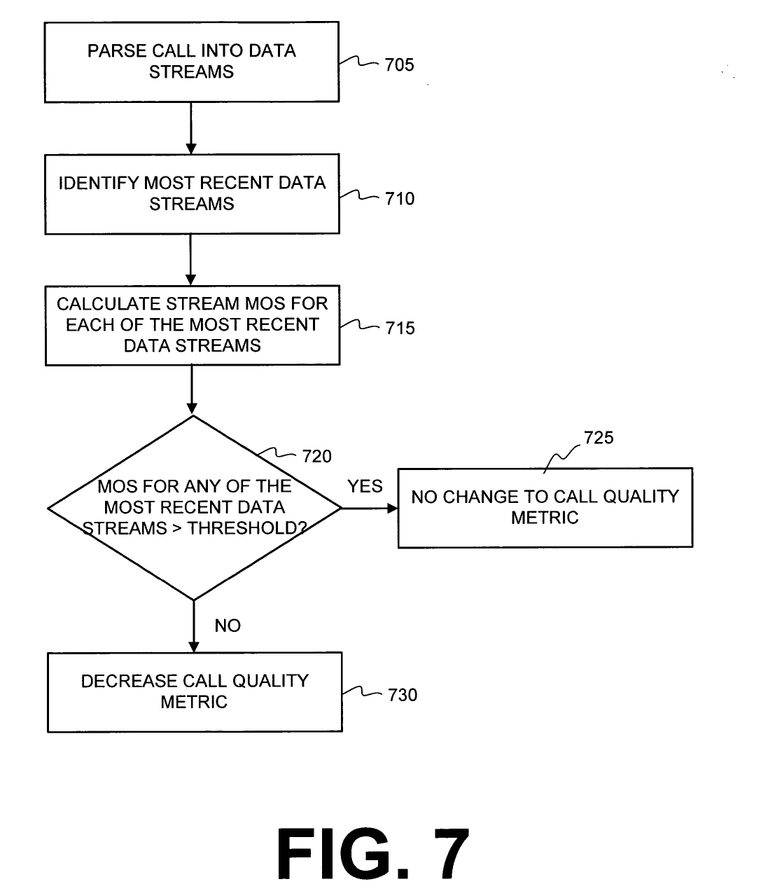

FIG. 7 is a process flow diagram of a method for calculating a call quality metric, according to an embodiment of the invention. As shown in FIG. 7, the process begins by parsing a call into data stream segments in step 705. For example, the process may use a predetermined data stream segment size of 200 packets.

Next, the process identifies the most recent data stream segments in step 710. For instance, the process may define the most recent 20% of data stream segments to be the most recent data stream segments. In such a case, if the session includes 50 data streams, then the last 10 data stream segments would be considered the most recent.

The process then calculates a stream MOS for each of the most recent data stream segments in step 715. Stream MOS can be calculated using APLR. And APLR can be determined as described above with reference to steps 505 and 510.

Next, in conditional step 720, the process determines whether the stream MOS for any of the most recent data stream segments is greater than a predetermined threshold value. If the result of conditional step is in the affirmative, the process advances to step 725 and does not make any adjustments to a call quality metric. If the result of conditional step 720 is in the negative, then the process advances to step 730 and decreases the value of a call quality metric.

Empirical Analysis

Experimentation was performed under various packet loss conditions to compare and validate embodiments of the invention.

FIG. 8A is a graph of packet loss vs. call quality for various burstiness levels based on the Perceptual Evaluation of Speech Quality (PESQ) algorithm. As illustrated in FIG. 8A, MOS values decrease with an increase in packet loss %. The three curves represent three different burstiness level (BL) conditions: a BL of 1 is random packet loss probability; a BL of 5 is moderate packet loss probability; and a BL of 10 is a high packet loss probability. The results illustrated in FIG. 8A support the notion that higher burstiness conditions translate to lower perceived call quality for loss packet loss rate conditions.

FIG. 8B is a graph of random packet loss vs. call quality as calculated by a conventional E-Model algorithm and enhanced E-Model algorithm (QModel) under random packet loss conditions. The QModel algorithm is consistent with embodiments of the invention described herein. The results illustrated in FIG. 8B suggest that the enhanced E-Model algorithm performs substantially similarly to the conventional E-Model algorithm in random packet loss conditions.

FIG. 8C is a graph of moderately bursty packet loss vs. call quality as calculated by a conventional E-Model algorithm and an enhanced E-Model algorithm (referred to in FIG. 8C as “QModel”). The QModel algorithm is consistent with embodiments of the invention described herein. The results illustrated in FIG. 8C illustrate that the enhanced E-Model algorithm advantageously results in lower MOS values than the conventional E-Model algorithm during moderate packet loss conditions, consistent with the PESQ predictions in FIG. 8A.

Taken together, FIGS. 8B and 8C illustrate that, when compared to the conventional E-Model, embodiments of the invention provide improved call quality measurements at moderately bursty packet loss conditions, without sacrificing accuracy at randomly bursty packet loss conditions.

An Exemplary Functional Architecture

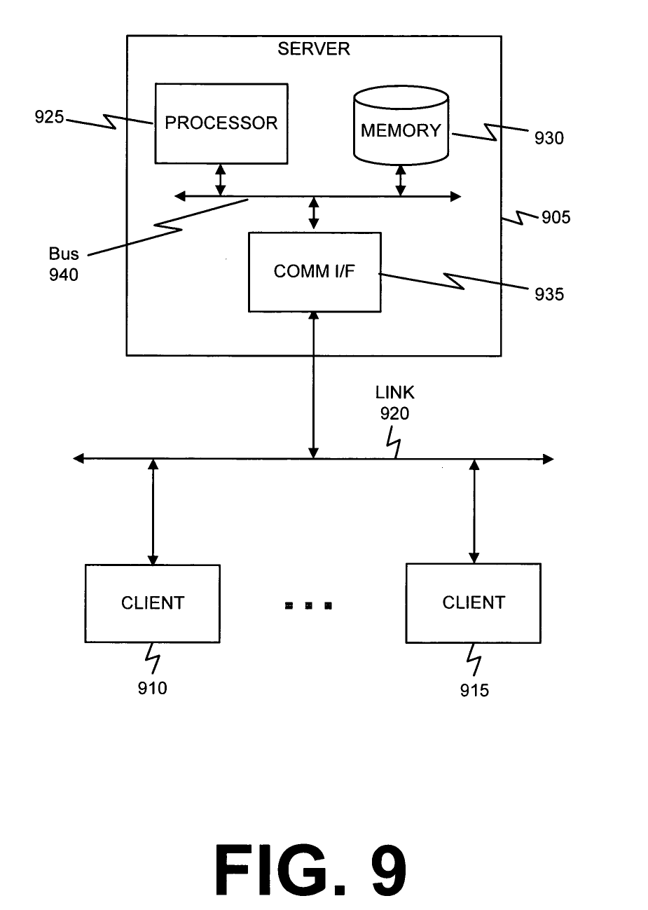

FIG. 9 is a block diagram of a functional architecture in which an embodiment of the invention can be used. As shown in FIG. 9, a server 905 is coupled to clients 910 and 915 via link 920. In addition, server 905 includes a processor 925, a memory 930 and a communications interface 935. The processor 925, memory 930 and communications interface 935 are coupled by a bus 940. As shown, the communications interface 935 is coupled to the link 920. The clients 910 and 915 may be VoIP telephones.

Components of the functional architecture are configured to execute the processes described above with reference to FIGS. 2, 3, 5 and/or 7. For example, code executable by processor 925 may be stored in memory 930. The code may include instructions so that the processor 925 can perform one or more processes described above with reference to FIGS. 2, 3, 5 and/or 7 as packet data is read by the server 905 via link 920 and communications interface 935.

In one embodiment, the data collection and/or calculations associated with one or more processes discussed with reference to FIGS. 2, 3, 5 and/or 7 is/are performed in the clients 910 and 915. Resulting quality data may then be reported to a central station (e.g., server 905). Or resulting data may be stored in the clients 910 and 915 until polled by the central station (e.g., server 905).

### Conclusion

The invention described above thus overcomes the disadvantages of known systems and method by adjusting a measured call quality metric based on the burstiness and/or recency of measured packet loss. While this invention has been described in various explanatory embodiments, other embodiments and variations can be effected by a person of ordinary skill n the art without departing from the scope of the invention. For example, different burstiness and/or recency measured could be implemented and different call quality metrics could be adjusted based on the measured burstiness and/or recency.

We claim:

1. A method for measuring the quality of a packet data stream comprising:
measuring the burstiness of the packet data stream;
calculating an equivalent random packet loss based on the measured burstiness; and
calculating a call quality metric based on the equivalent random packet loss.

2. The method of claim 1 wherein measuring the burstiness includes, selecting a data stream segment;
identifying a position of a lost data packet in said segment;
determining whether any additional data packets were lost within a predetermined number of preceding packets in said segment; and
setting a burstiness parameter based on said determining.

3. The method of claim 1 wherein calculating an equivalent random packet loss includes using said burstiness parameter.

4. A method for measuring the quality of a packet data stream comprising:
selecting a first packet in the packet data stream;
determining the loss status of a predetermined number of previous packets in the packet data stream, the previous packets being relative to the first packet; and
calculating an equivalent random packet loss for the first packet based on the loss status of each of the predetermined number of previous packets.

5. The method of claim 4, further comprising:
calculating an equivalent random packet loss for a second packet;
adding the equivalent random packet loss for the first packet to the equivalent random packet loss for the second packet.

6. A method for measuring the quality of a packet data stream comprising:
measuring an actual packet loss in the packet data stream;
calculating an actual packet loss rate based on the measured actual packet loss;
determining whether the actual packet loss rate is greater than a predetermined threshold;
if the actual packet loss rate is greater than the predetermined threshold, applying a first packet loss rate algorithm to calculate a call quality metric; and
if the actual packet loss rate is not greater than the predetermined threshold, applying a second packet loss rate algorithm to calculate a call quality metric.

7. A method for measuring the quality of a call comprising:
parsing the call into a plurality of data stream segments;
identifying at least one most recent data stream segment in the plurality of data stream segment; and
calculating an actual packet loss rate for the at least one most recent data stream segment.

8. The method of claim 5, further comprising:
determining whether the actual packet loss rate is greater than a predetermined threshold;
if the actual packet loss rate is greater than a predetermined threshold, decreasing the value of a call quality metric for the call.
